(19) United States
(12) Patent Application Publication
(10) Pub. No.: US 2017/0011064 A1
(43) Pub. Date: Jan. 12, 2017

(54) Methods and Apparatus for Sending or Receiving an Image

(71) Applicant: Pixxcell Worldwide Ltd., Penryn (GB)

(72) Inventors: Melissa Jane Mercer, Falmouth (GB); Andrew Richard Lindsay Weir, Newquay (GB)

(21) Appl. No.: 14/795,343

(22) Filed: Jul. 9, 2015

(51) Int. Cl. G06F 17/30; G06T 17/05; G06T 7/00; G06T 3/40; G06K 9/60

(52) U.S. Cl. CPC G06F 17/30241; G06F 17/30268; G06T 3/4038; G06K 9/60; G06F 17/3087; G06F 17/30017; G06T 7/0081; G06T 17/05; G06F 2216/01; G06T 2219/021; G06T 2219/2008; G06T 2219/2004

(57) ABSTRACT

Methods of sending an image include receiving, from a requesting device, a request for an image associated with a geographic area, generating the image by determining a plurality of photograph thumbnails, each photograph thumbnail being associated with a respective location or sub-region within the geographic area, and forming the image from the photograph thumbnails, and sending the image to the requesting device. A method of receiving an image includes sending, to a server, a request for an image associated with a geographic area, and receiving the image from the server, wherein the image comprises an image formed from a plurality of photograph thumbnails, each photograph thumbnail being associated with a respective location or sub-region within the geographic area.

### TECHNICAL FIELD

Embodiments as described herein relate to methods, apparatus and software for sending, receiving and/or displaying images, particularly images of geographical areas and photographs associated therewith.

### BACKGROUND

Many modern devices for taking photographs, such as digital cameras, mobile telephones and the like, include the ability to associate a date, time and geographic location with a photograph. For example, such devices include a clock for determining the date and time, and apparatus for determining the location of the device when taking a photograph, such as Global Positioning System (GPS) apparatus. Alternatively, a location can be associated with a photograph at a time after the photograph is taken, for example using the device taking the photograph or a different device. The internet has become a popular medium to share photographs, with billions of images being uploaded to various web sites that offer photo sharing services and often other services.

The internet can also be used to access map related services. Online mapping services such as Google Maps, Bing Maps and the like allow a user to view all or part of a world map in various forms, such as for example satellite imagery or outline forms.

### SUMMARY

According to a first aspect, a method of sending an image is provided, the method comprising receiving, from a requesting device, a request for an image associated with a geographic area, generating the image by, for each of a plurality of portions of the image, generating image data for the portion from data representing a geographic location or sub-region that is within the geographic area and associated with the portion, and forming the image from the portions, and forming the image from the photograph thumbnails, and sending the image to the requesting device.

According to a second aspect, a method of receiving an image is provided, the method comprising sending, to a server, a request for an image associated with a geographic area, and receiving the image from the server, wherein the image comprises a plurality of portions, each portion including image data illustrating data representing a geographic location or sub-region that is within the geographic area and associated with the portion.

### BRIEF DESCRIPTION OF THE DRAWINGS

Specific and non-limiting embodiments will now be described with reference to the accompanying Figures, in which:

FIG. 1 shows an example of a first view of a map;

FIG. 2 shows an example of a second view of a map;

FIG. 3 shows an example of a map tile, a masking layer and an overlay image;

FIG. 4 shows an example of the images and layers of FIG. 3 superimposed and in an exploded view;

FIG. 5 shows an example of apparatus that may be used in accordance with certain embodiments;

FIG. 6 shows an example of a method according to some embodiments;

FIG. 7 shows an example of a method according to some further embodiments;

FIG. 8 shows an example of a view of a map including overlay images; and

FIG. 9 shows an example of a user interface according to some embodiments.

### DETAILED DESCRIPTION OF SPECIFIC EMBODIMENTS

Online mapping services allow a user to view all or part of a world map using, for example, an internet browser on a desktop computer, laptop, tablet, mobile device or any other suitable device. A user may use controls such as a mouse and keyboard to change the portion of the world map displayed on a screen, change the zoom level, or interact with the map in a number of ways.

An example of an internet based mapping service will now be described. At a minimum zoom level, at which the greatest portion of the world map is displayed, the entire world map is contained within a 256 pixel by 256 pixel image, and this map image is sent by a server to the user's device. At this stage, the user may not zoom out any further, but may zoom in to, for example, display further detail in a selected portion of the world map. The world map is a two-dimensional flat representation of the globe, using for example the normalized Mercator projection.

At this zoom level, the user's device requests a single map tile from a server, and the server responds by sending the map tile to the user.

At each successive zoom level, the world map is represented by a new set of images called map tiles. Each map tile typically is a square image with a resolution of 256×256 pixels, though in other embodiments the map tiles may have different shapes and/or sizes. As the user zooms in one level, the number of map tiles representing the world map doubles on both the horizontal and vertical axes, such that the number of map tiles is four times the number of tiles for the previous zoom level.

Only a limited number of tiles may be transmitted to and displayed by the user. For example, at a screen resolution of 1024×768 pixels, the user's screen may display up to twelve map tiles at a selected zoom level. Therefore, at a particular zoom level, for example when the user has changed the portion of the map being displayed or has changed the zoom level, the user's device sends multiple requests to the server for each map tile to be fully or partially displayed on the user's screen. Map tiles to be partially displayed may comprise for example those located at the edges of the user's screen (or a window on the screen used for map viewing). The server responds to each request by sending the appropriate map tiles to the user's device, where they may be displayed on the screen.

Embodiments as described herein provide for the transmission of further image information from a server to the user's device. For example, the server may be the same server as that which provides the mapping services described above, or may be a different server. The further image information comprises one or more images referred to herein as map tile overlays. Each map tile overlay contains a plurality of photograph thumbnails, each thumbnail being associated with a respective location or sub-region. The further image information may also comprise a masking layer, which indicates areas of the overlay image which are blank or do not contain a photograph thumbnail.

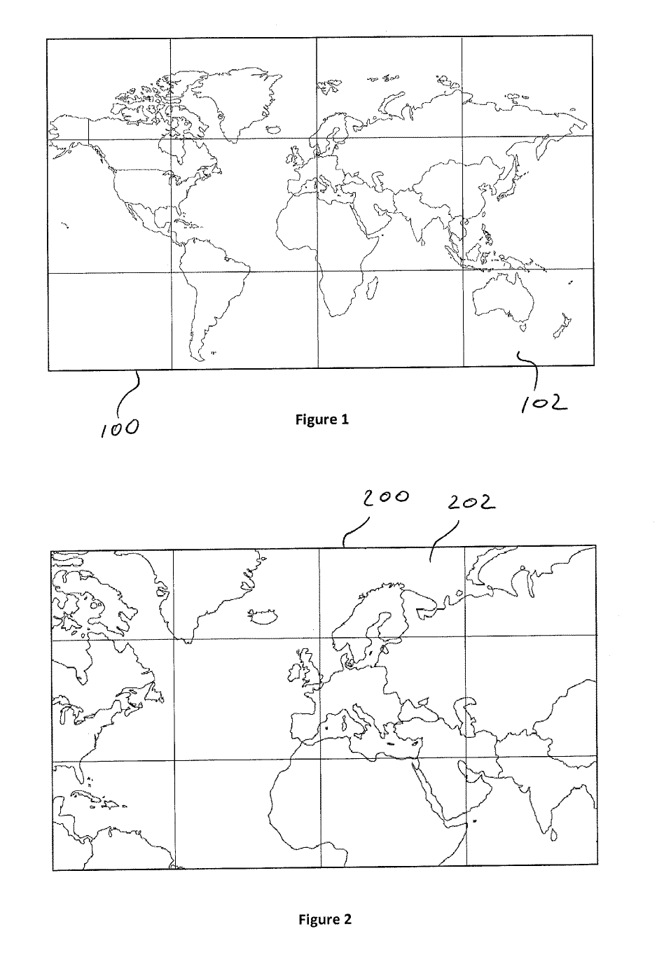

FIG. 1 shows an example of a world map 100 in outline form, which may be displayed on the screen of a user's device, at a selected zoom level. The world map 100 may be contained within a window on the user's screen, or alternatively may fill the entire screen. The screen may also display other information or controls, which are not shown. The world map 100 is divided into a number of map tiles 102 as shown. For example, each map tile may be a square image of 256×256 pixels, though in other embodiments other map tile sizes or shapes may be used. The map tiles may also in other embodiments vary in size and/or shape. Each map tile is associated with a geographic area, in that it provides a graphical representation of the geographic area represented by that map tile.

FIG. 2 shows an example of a second world map display 200, after the user has zoomed in one or more levels. The displayed map 200 includes the same number of tiles as the first world map 100, as each tile 202 is substantially the same size (for example, 256×256 pixels). However, each tile represents a smaller geographic area than those in the first map 100, and hence includes more detail.

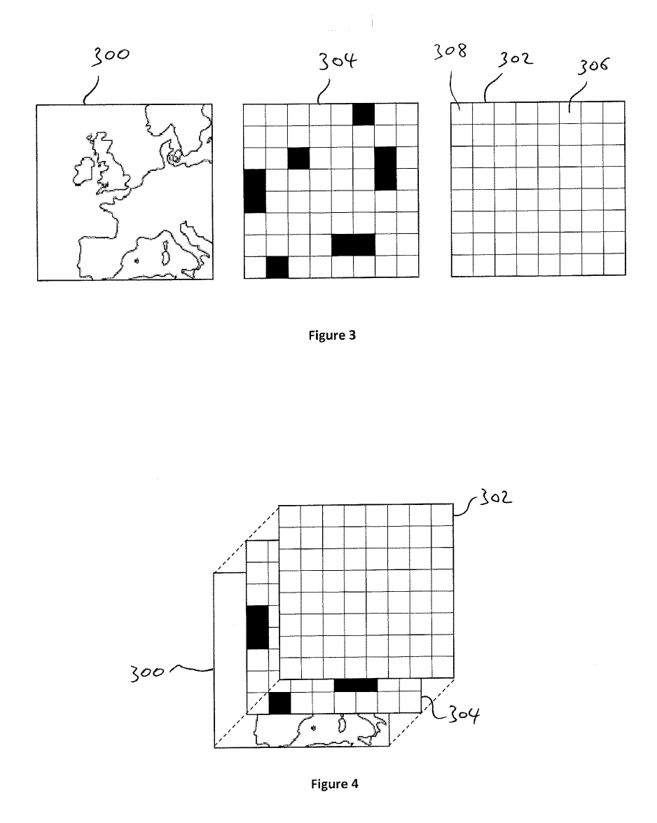

FIG. 3 shows an example of a map tile 300 at a particular zoom level, an overlay image 302, and a masking layer 304. In embodiments described herein, map tile overlay image 302 may be generated, and masking layer 304 may also be generated. In some embodiments, as described herein, the map tile 300 and overlay image 302 represent the same geographic area and are the same size and resolution (for example, 256×256 pixels), though in other embodiments the map tile 300 and overlay image 302 are of different sizes and/or represent different geographic areas. However, where for example the overlay image is to be displayed at least partially above or covering the map tile 300, there is at least some overlap between the respective geographic areas represented by the tile 300 and overlay image 302. In particular embodiments, the geographic areas are identical, and the size and resolution of the map tiles and overlay images are also identical. As such, an overlay image may be displayed on top of a map tile, such that the edges of the map tile and overlay image coincide on a display.

The overlay image 302 comprises a plurality of image thumbnails, such as for example thumbnail 308, arranged in a grid. Each thumbnail image is located in a portion of the overlay image 302 such that each thumbnail may be associated with a location or a sub-area of the geographic area represented by the overlay image 302, which in some embodiments is the same geographic area as that represented by the map tile 300. In the example shown, the overlay image is a square 256×256 pixel image, with 64 thumbnails each at a resolution of 32×32 pixels arranged in an 8×8 square grid. However, in other embodiments, other arrangements, sizes and/or shapes of the thumbnails may be used.

In some embodiments, the size of the thumbnails remains constant, such as at 32×32 pixels each for example, and is also the same for all thumbnails across the overlay image. However, in alternative embodiments, the size of the thumbnails may depend on zoom level. As an example, at the minimum zoom level the thumbnails in an overlay image may be arranged in a 32×32 grid, with each thumbnail being an 8×8 pixel square, whereas at a maximum zoom level a 2×2 grid may be used, with the four thumbnails each being a 128×128 pixel square. In this way, assuming that the map overlay images remain the same size such as 256×256 pixels regardless of zoom level, the thumbnail size may increase as the user zooms in, and thus each map overlay image will include fewer thumbnails. The size of the thumbnails may be set arbitrarily for each zoom level.

The geographic sub-area “underneath” each thumbnail may additionally or alternatively depend on zoom level. For example, in some embodiments, the sub-area “underneath” each thumbnail (that is, the geographic area underneath the thumbnail) may decrease as the user zooms in. This may provide the user with a greater number of thumbnails for a given geographic area as the user zooms in, again giving the impression of zooming in to the user.

Providing a plurality of thumbnails in a single image as described above for an overlay image reduces communication overhead considerably compared to communicating each thumbnail as a separate image. For example, an overlay image may include overhead for sending one image whereas sending a grid of 32×32 thumbnails may have a communication overhead that is 1024 times greater.

In some embodiments, the thumbnails may be arranged in a grid such that there are no gaps between the thumbnails, apart from where portions of the overlay image may be transparent as explained further below. In other embodiments, a small gap or border may be provided between thumbnails to enable visual differentiation between the thumbnails.

In some embodiments, there may be thumbnails missing from the overlay image 302. This may be because there are no images associated with the geographic area underneath where the thumbnail should be, there are no images that meet the user's criteria, and/or thumbnails are not displayed for predetermined geographic areas. In such embodiments, the overlay image may include blank areas or other data in place of one or more of the thumbnails in the overlay image 302. In some embodiments, the overlay image is associated with a masking layer 304 as shown in FIG. 3. The masking layer includes data that describes locations in the overlay image, if any, where there are no thumbnails. In the example shown in FIG. 3, the masking layer 304 includes a black space indicating that position 306 in the overlay image 302 does not include a thumbnail, and a white space indicating that position 308 in the overlay image includes a valid thumbnail. A user interface may, for example, display areas without thumbnails as transparent portions such that parts of the underlying map tile may be seen. Additionally, these parts may be darkened to indicate that these parts have no associated thumbnail—for example, no photographs are available that have location information within that particular geographic sub-area.

FIG. 4 shows an example of how a map tile 300, overlay image 302 and masking layer 304 may be arranged on a user's display. There may be other map tiles, overlay images and masking layers (not shown) displayed simultaneously. In the arrangement in FIG. 4, an exploded view is shown though on the user's display the images may be displayed in a fully overlapping stack. In this example, each of the map tile, overlay image and masking layer are of the same size. The map tile 300 is displayed at the bottom, with the overlay image 302 at the top. The masking layer 304 is shown between the map tile 300 and the overlay image 302.

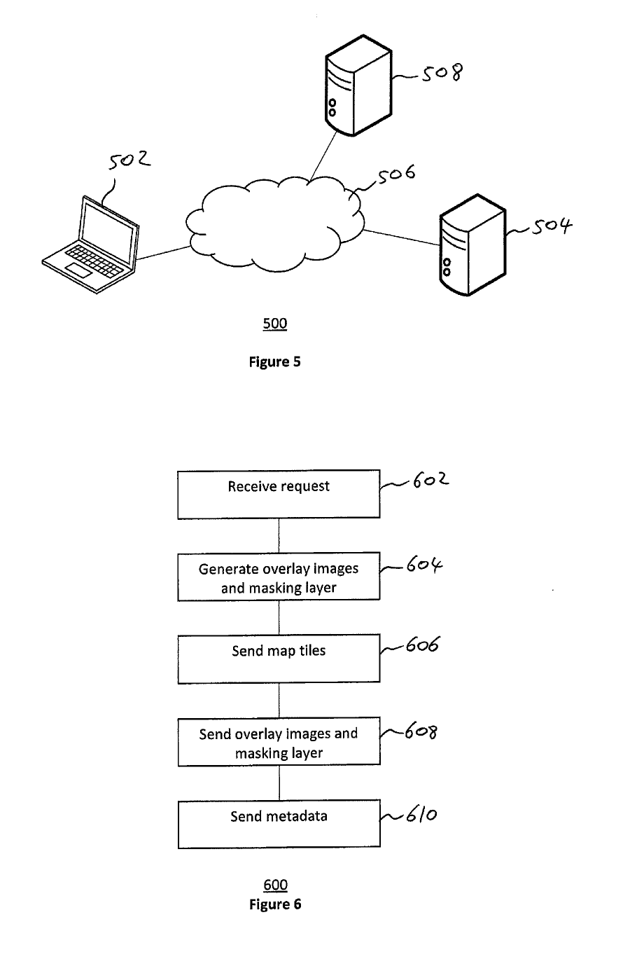

FIG. 5 shows an example of apparatus 500 that may be used to implement embodiments of the invention. The apparatus 500 includes a user's device 502 and a server 504. The device 502 and server 504 may be able to communicate via the internet 506, and any further networks that may be necessary such as mobile networks, local area networks and the like. The user's device 502 can communicate with the server 504 to request and download map overlay images. In some embodiments, the server 504 may also be able to provide map tiles to the user's device 502. The server 504 may store the appropriate map tiles or may request and retrieve the map tiles from a further server 508 (such as a mapping service server) for forwarding to the device 502. In still further embodiments, the user's device 502 may retrieve the map tiles and overlay images from different servers, such as the overlay images from the server 504 and the map tiles from the server 508.

FIG. 6 shows an example of a method 600 implemented by a server according to some embodiments. In a first step 602, the server receives a request from a requesting device such as the user's device 502. The request may be for one or more overlay images associated with one or more geographic areas. In a second step 604, the server generates the overlay image (or images) by, for each overlay image, determining a plurality of photograph thumbnails, each photograph thumbnail being associated with a respective location or sub-region within the geographic area, and forming the overlay image from the photograph thumbnails. The request may also include one or more requests for map tiles, for example map tiles that are associated with the same geographic area as the requested overlay images. In this step, the server may generate a masking layer, such as that shown in FIGS. 3 and 4.

In some embodiments, the request may also include one or more criteria for the thumbnails. For example, the criteria may specify that the thumbnails relate to photographs that were taken within a certain date range, include a certain subject or person, and/or other criteria.

Determining the photograph thumbnails may comprise, for example, searching a database of photographs to find photographs that are associated with the geographic location or sub-area (e.g. the photographs that have location information within the location or sub-area) and, where one or more criteria are specified, photographs that meet those criteria. Where multiple photographs are found, an appropriate thumbnail is determined. For example, the thumbnail may be determined from the latest photograph, the most popular photograph, or compiled from multiple photographs. Where no photographs are found, the thumbnail may be for example a blank portion of the overlay image, or a transparent portion of the overlay image. The database of photographs may be located locally to the server 504 or elsewhere, for example accessible over the internet 506.

In some embodiments, where an overlay image is made up of a plurality of thumbnails of fixed sizes and positions within the overlay image, location information within or associated with a photograph will determine the position within the overlay image a thumbnail of that photograph should be placed. Therefore, in some embodiments, generating an overlay image includes, for a thumbnail position, determining a photograph with location information within an area “underneath” the thumbnail position and inserting a thumbnail of that photograph in that position. Here, the area “underneath” the thumbnail position may be the area of the world map which should lie underneath the overlay image when the overlay image is displayed. For example, in embodiments where the world map is a 2D Mercator projection, known techniques can be used to translate location information to a position on the world map. Therefore, for a particular thumbnail in an overlay image, embodiments may determine whether a particular photograph thumbnail should be inserted at that thumbnail position. In other embodiments, which use different 2D projections or where a 3D (e.g. spherical) world map is to be displayed, appropriate calculations may be used to determine which photograph thumbnails could be inserted at a particular thumbnail position in an overlay image, and may additionally be used to determine the position and/or shape of the overlay image (as well as the underlying map tile and any other layers) on the user's display.

In a third step 606, in some embodiments, where the request from the user's device includes requests for map tiles, these map tiles are sent to the user's device. For example, as indicated above, these map tiles may be stored locally at the server 504 or retrieved from the server 508 for forwarding to the user's device 502.

In a fourth step 608, the overlay images (and masking layer, if any) generated in step 604 are sent to the user's device. In some embodiments, where the device 502 or a different device requests an identical overlay image to one generated previously, the method may skip the generating step 604 and instead send a locally stored or cached overlay image. In some embodiments, most or all overlay images covering the whole world map may be pre-rendered and stored in a manner accessible to the server 504, for one or more zoom levels. For example, these zoom levels may include the minimum zoom level as shown in FIG. 1, and/or one or more further zoom levels. For higher zoom levels, where the number of overlay images becomes a large number, or for cases where the user specifies certain criteria for the thumbnails, the overlay images may be dynamically generated in step 604 and may also be cached.

In a fifth step 608, metadata is sent to the user's device 502. The metadata contains information about the overlay images. The metadata may contain information relating to all overlay images sent to the user's device, or alternatively each overlay image may be associated with a separate block of metadata. The information in the metadata may describe, for example, the locations, sizes and/or shapes of the thumbnails in an overlay image. The metadata may also include information or instructions to allow a user to interact with each thumbnail. In this way, the user interface of the user's device may be able to allow the user to interact with the thumbnails. For example, if a user selects a particular thumbnail image through interaction with the user's device, such as “clicking” on a particular thumbnail displayed on the user interface, the metadata may include information or instructions that causes the user interface to display further information associated with that thumbnail or the geographic sub-area underneath. In one example, the user interface may display a plurality of photographs that are associated with the geographic sub-area, and these photographs may include the photograph used to produce the selected thumbnail. The information or instructions my have any suitable form but may include, for example, executable instructions or internet addresses (“web links”).

As described above, a large number of thumbnail images may be transmitted to the user in the form of a number of overlay images, each overlay image including a plurality of the thumbnail images. If each thumbnail image were to be transmitted to the user as individual images, if transmitted sequentially this would result in the time taken for the user's device to retrieve the thumbnails being prohibitively long due to transmission overhead associated with each individual image as described above. On the other hand, if the user's device requested each individual thumbnail as a separate request in parallel, thus requiring a large number of simultaneous connections to be opened between the user's device and the server, this may add resource requirements to the server and may also cause the server to become overloaded as well as adding significantly to the transmission overhead. Thus, embodiments of the invention as described herein allow for transmission of a large number of thumbnails to the user in a timely manner, in the form of a reduced number of overlay images, and where metadata is also transmitted the information contained therein may allow the user's device to present the thumbnails to the user in a manner whereby they can be individually interacted with. Thus the number of simultaneous connections between a user's device and a server and/or the number of images to be sequentially downloaded is reduced compared to an embodiment where each thumbnail must be retrieved as a separate image.

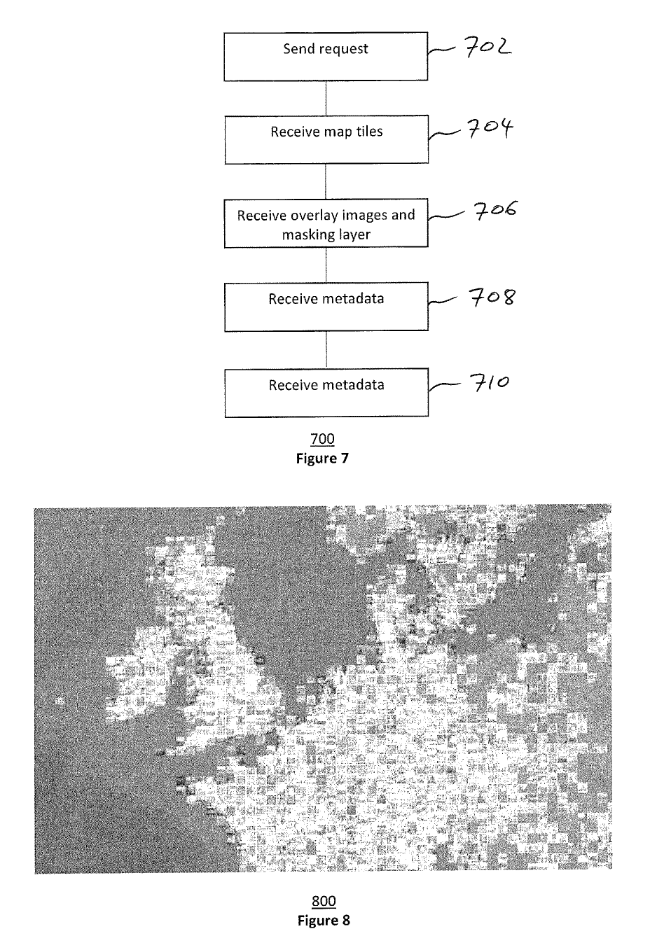

FIG. 7 shows an example of a method 700 according to embodiments of the invention that may be implemented for example by a user's device. The method 700 starts at step 702, where the user's device sends a request to a server. The request comprises a request for an overlay image associated with a geographic area, such as a geographic area currently being viewed on the user's screen for example. The request may comprise multiple requests, each request relating to a single overlay image that is to be displayed on the user's screen. The request may in some embodiments also include requests for map tiles associated with the same or similar geographic area.

In step 704, in some embodiments, the map tile or tiles are received from the server, though in some embodiments the map tiles may be retrieved from elsewhere, such as the server 508 shown in FIG. 5. In other embodiments, the user's device may not display map tiles at all, in which case step 704 may be omitted.

In step 706, the overlay image or images are received from the server, along with a masking layer (if any), and in step 708, metadata is received from the server (or other location). Finally, in step 710, the overlay images are displayed on the screen of the user's device. This can be achieved in a number of ways. For example, the map tiles (if received) can be displayed, with the overlay images displayed on top of the map tiles such that the geographic area represented by one of the map tiles, for example, corresponds to the geographic area represented by the overlay image (or portion thereof) displayed over the map tile. The overlay images may be displayed as partially transparent to allow the user to view the map tiles “underneath” the overlay images. Additionally or alternatively, the overlay images may include transparent portions as indicated in a masking layer, through which the map tiles or portions thereof may be seen. In some embodiments, where no map tiles are received, only the overlay images are displayed. The user's device may also allow interaction with some or all of the thumbnails, the manner of interaction being indicated in metadata as indicated above.

The final look of the user interface on the user's display may resemble a tessellated look. For example, as the user is viewing a particular portion of a world map, such as the whole world map or a fraction of it, the user may be presented with a large number of small thumbnail images over the world map arranged in a grid, including transparent areas as indicated above in any positions where there are no thumbnails. In some cases, the world map can be seen underneath the thumbnails or the general outline of land masses may be evident to the user, such as for example from the positions of areas with no thumbnails (as remote ocean areas may have no associated photographs, for example) or otherwise evident from the appearance thumbnails themselves. In some cases the user may be able to zoom into particular areas, thus perhaps displaying more thumbnails in these areas, and may also be able to interact with the thumbnails to display further information or user interfaces, for example other photographs or thumbnails from the same geographic sub-area as a selected thumbnail.

FIG. 8 shows an example of a screen, window or user interface 800 of a user's device, displaying a 2D user interface according to embodiments of the invention. Map tiles can be seen through transparent portions of the overlay images, which do not include any thumbnails, whereas thumbnails over the map tiles can also be seen. Although not shown, the map tiles and overlay images may be instead displayed in a 3D manner, such as for example on a 3D globe.

As noted above, any one or more of the thumbnails presented to the user may allow the user to interact with it. For example, the user may select or click on a thumbnail, or where the user is using a touchscreen, touch or press the thumbnail. Once the user interacts with a thumbnail, a link or instructions may be invoked to carry out further actions related to the selected thumbnail.

In one example, a stack of photographs is presented to the user. The stack may comprise the photographs that include location information within the area covered by the selected thumbnail. The stack may also comprise only those photographs that meet selected criteria, such as date range, subject and other criteria.

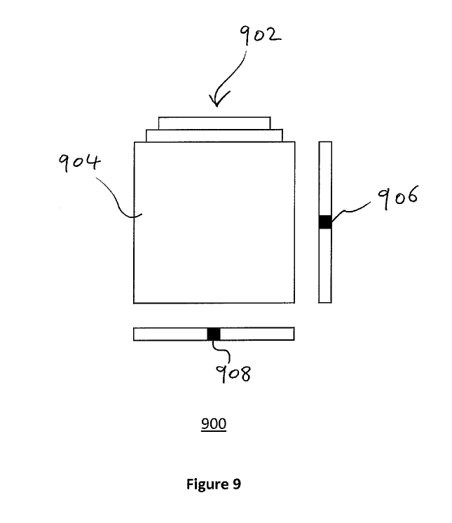

FIG. 9 shows an example user interface 900 presented to the user once a thumbnail has been interacted with. The user interface 900 displays a stack 902 of photographs. In this example, the photographs are displayed on top of each other in a slightly offset manner such that a photograph lower in the stack is mostly but not entirely covered by a photograph higher in the stack. The user interface 900 displays a photograph 904 on the “top” such that it is not obscured by any other photographs. The user interface 900 includes a first control 906 that the user may manipulate to change which photograph in the stack 902 that is displayed as the top photograph 904. In this example, the user may move the control 906 in a vertical direction to change the top photograph 904. The user interface 900 also includes a second control 908 that the user may manipulate to change the date and/or time associated with the stack 902 (this may also change the top photograph to one that is taken from the new stack). In this example, the user may move the control 908 in a horizontal direction. Manipulating the control 908 may replace some or all of the photographs in the stack 902 with photographs associated with a different date, time, or range of date or time in accordance with the control 908. As such, as different stack may be displayed. Additionally or alternatively, manipulation of the control 908 may replace the top photograph 904 with a photograph associated with a date or time in accordance with the control 908.

In other embodiments, other parts of the user interface may be manipulated. For example, the user may manipulate the displayed photographs themselves to change the photograph on the “top” of the stack, and/or to change the date/time of the photograph or stack being displayed. This may be done for example by the user carrying out a click and drag gesture, or on a touchscreen a “swipe” gesture, on the photograph on the “top” of the stack or another part of the user's screen. In one example, a horizontal gesture may change the date/time associated with the stack, whereas a vertical gesture may change the photograph to a different one in the stack. In embodiments where the top photograph or other parts of the user's display can be manipulated in this way, the controls 906, 908 may be absent. Additionally or alternatively, other gestures and/or controls may be available to manipulate the user interface.

The above description relates specifically to embodiments where the overlay image is generated using a plurality of photograph thumbnails, for example arranged in a grid. Other embodiments, however, may use other data to generate the overlay image. For example, the overlay image may comprise a plurality of portions, each portion associated with a geographic location or sub-area—for example, each portion representing the geographic sub-area that is intended to reside “underneath” the portion when the overlay image is displayed. The portion may be generated to include image data that illustrates or represents data associated with the corresponding geographic sub-area “underneath” the portion. In this way, an overlay image may be generated that gives a visual representation of data associated with or representing the geographic locations or area associated with the overlay image. Each portion may comprise a plurality of pixels (such as 32×32 for example), may comprise a single pixel, and/or may be the same size or a different size compared to other portions of the overlay image.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or “connected”, as generally used herein, refer to two or more elements that may be either directly connected or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values or distances provided herein are intended to include similar values within a measurement error. The use of “device” and “server” herein each refer to a single data storage and/or processing apparatus, or multiple such apparatuses located for example in a single location or at distributed locations and connected to each other and/or another device via one or more networks such as the internet.

Although methods, devices and electronic components have been disclosed in the context of certain preferred embodiments and examples, it will be understood by those skilled in the art that this disclosure extends beyond the specifically disclosed embodiments to other alternative embodiments and/or uses and modifications and equivalents thereof. In addition, while several variations have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the disclosed embodiments. Thus, it is intended that the scope of the present invention herein disclosed should not be limited to the particular disclosed embodiments described above, but should be determined by a fair reading of the claims that follow.

1. A method of sending an image, the method comprising:
receiving, from a requesting device, a request for an image associated with a geographic area;
generating the image by, for each of a plurality of portions of the image, generating image data for the portion from data representing a geographic location or sub-region that is within the geographic area and associated with the portion, and forming the image from the image data generated for the portions; and
sending the generated image to the requesting device.

2. The method of claim 1, further comprising sending at least one map tile to the requesting device, each map tile comprising an image of a portion of a world map wherein at least one of the at least one map tile comprises an image of a portion of the world map corresponding to the geographic area.

3. The method of claim 1, wherein the request includes a zoom level of a user interface on which the image is to be displayed, and generating the image further comprises basing a size and/or resolution of the image at least in part on the zoom level.

4. The method of claim 1, wherein the data representing the geographic location or sub-region associated with a portion of the image comprises a photograph thumbnail associated with the geographic location or sub-region.

5. The method of claim 1, wherein generating the image data for each portion of the image comprises determining a thumbnail of at least one photograph in a plurality of photographs associated with the location or sub-region associated with the portion.

6. The method of claim 5, wherein the request includes an indication of a time period, and wherein the plurality of photographs associated with the location or sub-region comprise a plurality of photographs also associated with the time period.

7. The method of claim 1, wherein the location or sub-region associated with a portion of the image comprises a geographic area associated with an area on the image on which the portion is located.

8. The method of claim 1, further comprising generating metadata associated with the image and sending the metadata to the requesting device, wherein the metadata includes information indicating at least one of the size, resolution and/or position of at least one of the portions in the image.

9. The method of claim 8, wherein the metadata includes information and/or instructions associated with at least one of the portions and/or associated with the geographic sub-area associated with the at least one of the portions.

10. A method of receiving an image, the method comprising:
sending, to a server, a request for an image associated with a geographic area; and
receiving the image from the server, wherein the image comprises a plurality of portions, each portion including image data representing an image associated with a geographic location or sub-region that is within the geographic area and associated with the portion.

11. The method of claim 10, further comprising receiving at least one map tile from the server, each map tile comprising an image of a portion of a world map.

12. The method of claim 11, wherein at least one of the at least one map tile comprises an image of a portion of the world map corresponding to the geographic area.

13. The method of claim 10, wherein the request includes a zoom level of a user interface on which the image is to be displayed, and a size and/or resolution of the image and/or the portions is based at least in part on the zoom level.

14. The method of claim 10, wherein the data representing the geographic location or sub-region associated with a portion of the image comprises a photograph thumbnail associated with the geographic location or sub-region.

15. The method of claim 10, wherein each portion comprises a thumbnail of at least one photograph in a plurality of photographs associated with the location or sub-region associated with the portion.

16. The method of claim 15, wherein the request includes an indication of a time period, and wherein the plurality of photographs associated with the location or sub-region comprise a plurality of photographs also associated with the time period.

17. The method of claim 10, wherein the location or sub-region associated with a portion of the image comprises a geographic area associated with an area on the image on which the portion is located.

18. The method of claim 10, further comprising receiving metadata from the requesting device, wherein the metadata includes information indicating at least one of the size, resolution and/or position of at least one of the portions in the image.

19. The method of claim 18, wherein the metadata includes information and/or instructions associated with at least one of the portions and/or a geographic sub-area associated with the at least one of the portions.

20. The method of claim 19, wherein the information and/or instructions cause a user interface to display a photograph from a plurality of photographs associated with the location or sub-region associated with the portion, and to present at least one control for causing the user interface to change the displayed photograph to another of the plurality of photographs, wherein the at least one control allows a user to select the photograph based on a date and/or time associated with the photograph and/or other criteria associated with the photograph.

21. The method of claim 10, further comprising displaying the image over a world map image, and displaying at least some portions of the image as transparent or semi-transparent portions such that corresponding portions of the world map image are visible under the displayed image.

22. The method of claim 21, wherein at least one of the portions of the image is associated with information and/or instructions, and wherein the method further comprises allowing a user to interact with at least one of the portions of the image so as to display the information or execute the instructions.

23. Apparatus for sending an image, the apparatus comprising:
reception apparatus configured to receive, from a requesting device, a request for an image associated with a geographic area;
generating apparatus configured to generate the image by, for each of a plurality of portions of the image, generating image data for the portion from data representing a geographic location or sub-region that is within the geographic area and associated with the portion, and to form the image from the portions; and
transmission apparatus configured to send the image to the requesting device.

24. Apparatus for receiving an image, the apparatus comprising:
transmission apparatus configured to send, to a server, a request for an image associated with a geographic area; and
reception apparatus configured to receive the image from the server, wherein the image comprises a plurality of portions, each portion including image data illustrating data representing a geographic location or sub-region that is within the geographic area and associated with the portion.

25. A non-transitory computer readable medium having stored thereon computer-executable instructions that, when executed cause at least one processor to:
receive, from a requesting device, a request for an image associated with a geographic area;
generate the image by, for each of a plurality of portions of the image, generating image data for the portion from data representing a geographic location or sub-region that is within the geographic area and associated with the portion, and forming the image from the portions; and
send the image to the requesting device.

26. A non-transitory computer readable medium having stored thereon computer-executable instructions that, when executed cause at least one processor to:
send, to a server, a request for an image associated with a geographic area; and
receive the image from the server, wherein the image comprises a plurality of portions, each portion including image data illustrating data representing a geographic location or sub-region that is within the geographic area and associated with the portion.

27. A user interface comprising:
at least one displayed map tile; and
at least one image comprising a plurality of portions, each portion including image data illustrating data representing a geographic location or sub-region that is within the geographic area and associated with the portion, wherein the at least one image is displayed over the at least one map tile.

28. The user interface of claim 27, wherein one or more portions of the at least one image specified by masking data are displayed as transparent or partially transparent.

29. The user interface of claim 27, wherein at least one of the portions of the at least one image is associated with information and/or instructions, and wherein the user interface is arranged to allow a user to interact with at least one of the portions of the image so as to display the information or execute the instructions.

30. The user interface of claim 29, wherein the information and/or instructions cause a user interface to display a photograph from a plurality of photographs associated with the location or sub-region associated with the portion, and to present at least one control for causing the user interface to change the displayed photograph to another of the plurality of photographs, wherein the at least one control allows a user to select the photograph based on a date and/or time associated with the photograph and/or other criteria associated with the photograph.

31. The user interface of claim 30, wherein unselected photographs of the plurality of photographs are not displayed and/or are displayed at least partially covered by the selected photograph.
